(19) United States
(12) Patent Application Publication
(10) Pub. No.: US 2009/0229895 A1
(43) Pub. Date: Sep. 17, 2009

(54) AUTOMOBILE VEHICLE PUSHER SYSTEM, HYBRID OR ELECTRICAL VEHICLE COMPRISING THE VEHICLE PUSHER SYSTEM AND A METHOD OF CONVERTING A VEHICLE TO HYBRID OR ELECTRICAL PROPULSION

(76) Inventor: Gregory A. Gibbs, Madison, AL (US)

Correspondence Address: MICHAEL RIES, 318 PARKER PLACE, OSWEGO, IL, 60543, US

(21) Appl. No.: 12/403,365

(22) Filed: Mar. 12, 2009

Related U.S. Application Data
(60) Provisional application No. 61/036,910, filed on Mar. 14, 2008.

(51) Int. Cl. B62M 7/14

(52) U.S. Cl. 180/11

(57) ABSTRACT

The invention provides an automobile vehicle pusher system, a hybrid or an electrical propulsion vehicle, and a method of reversibly converting a vehicle to hybrid or electrical propulsion. In a preferred aspect the invention provides such a system that can be reversibly connected to a trailer hitch or similar type device at the rear of a vehicle to provide propulsion in whole, or in part, for the vehicle. A further preferred embodiment includes connections and apparatus for charging of the electrical power storage components to provide a plug-in hybrid or plug-in electric only vehicle.

This application claims priority to U.S. Provisional Application 61/036910 filed 14 Mar. 2008, the entire disclosure of which is incorporated by reference.

### FIELD OF THE INVENTION

The field of the present invention relates generally to an automobile vehicle pusher system, a hybrid or an electrical propulsion vehicle, and a method of reversibly converting a vehicle to hybrid or electrical propulsion. In a preferred aspect the invention relates to such a system that can be reversibly connected to a trailer hitch or similar type device at the rear of a vehicle to provide propulsion in whole, or in part, for the vehicle.

### BACKGROUND OF THE INVENTION

Traditionally, internal combustion engines have been utilized as the primary direct drive power source for automotive vehicles. Due to the increased cost of gas, diesel and other fossil based fuels, many car manufactures and researchers have considered hybrid vehicles and most have maintained the combustion engines as the primary power source for the drive train, while integrating into the drive train of the vehicle electrical propulsion systems. Such hybrids use the combustion engines as the primary drive source and may utilize electrical motors of the drive train as a secondary drive train or as a supplemental drive train source. An example of a popular hybrid is the Prius.

While large auto manufacturers make hybrid vehicles that tend to be much more expensive that similar sized vehicles, there is no readily available and economical kit for temporarily or permanently converting an older combustion engine vehicle to electrical or hybrid propulsion without major revision of the vehicle. Such conversions tend to be irreversible and expensive conversions to an all-electric vehicle as described below.

Plug in “electric only” vehicles have existed for some time, specifically for more than 30 years (for example, “Electric Vehicles Design and Build Your Own” Second Edition, by Michael Hackleman, Earthmind Publishers, Mariposa, Calif. 1977; ISBN: 0915238179).

As suggested by Hackleman, combustion engine vehicles can be converted to electric only vehicles. In addition, Hackeman describes the use of large trailers for generators or “pusher” vehicles to extend the range of the electric-only converted vehicles. Among others David Coale and his team converted an MGB midget to an all electrical power train around year 2000 in order to utilize a small electrical motor that was attached to the transmission via an adapter and used lead acid batteries as a power source, which were charged via house electrical current by use of a special charging device. Such vehicles have a very limited driving range between charging and the lead acid batteries that were use as a primary stored electrical power source are both heavy and need to be replaced frequently. See www.acterra.org for examples of such all electric conversions. A number of vendors including Santa Cruz EV provide kits to convert a number of combustion engine cars over to all electric vehicles. Other all electric vehicles such as the Tesla vehicle have gotten strong review, but they use battery packs made from Nichol cadmium, Nichol hydride, lithium hydride batteries and the like, some of which can overheat and catch fire when suddenly charging or discharging.

All of these vehicles suffer from other drawbacks and shortcomings that limit their commercial acceptance or use. For example, combustion engine vehicles that are converted to all electric vehicles typically use expensive deep cycle or marine batteries that are limited to 200 to 750 charge and discharges cycles, and typically expensive battery pack replacement 20 with one or two years or use, or even less. Moreover, the charge/discharge ranges for such vehicles are typically from about 25 to 80 miles at a cruising speed of about 55 mph or more, depending upon the number and type of batteries used. Longer range converted vehicles often need to be modified to carry the heavy load of a large number of batteries, which also cuts into the efficiency of a vehicle in addition to creating extra vehicle wear from the load. While deep cycle and marine batteries have more durable lead plates and permit these battery types to be discharged to 80% or 90% before they are recharged, they also require frequent maintenance.

Electrical vehicles sometimes employ a large trailer or employ a modified portion of a vehicle that can be attached as a trailer to assist the electrical power train of the vehicle with propulsion of the vehicle. Likewise generators or additional battery packs have been located on a trailer-like device to increase the range for an electrical vehicle. Such are often bulky and unsightly, and can present a road hazard by failing to have braking systems that adequately coordinate with the main vehicle's braking system. Moreover, such large trailers are often adapted to a particular vehicle system and are not easily utilized with a different vehicle.

Accordingly, there is a need for a substantially universal apparatus and kit for reversibly converting a combustion engine vehicle to provide for intermittent hybrid or electric-only propulsion that is highly coordinated with the braking system of the vehicle as well as with its directional and hazard signaling and propulsion system. Particularly, needed is a system that is simple to install and use that can be remove when it is not needed or desired without affecting the operability of the original vehicle. There is also a need for apparatus to address the cost of the fuel crisis while reducing the average environmental emissions of the vehicle by reducing an automotive vehicle's energy consumption and therefore reducing the emissions of the vehicle per mile of travel.

### DEFINITIONS

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below. “Combustion Engine Drive Hybrid” or “CIDH” as referred to in this document refers to an automotive vehicle where the combustion engine is attached directly or indirectly to the drive train of the vehicle and is the primary power source for the drive train. An example of such a vehicle is a Toyota Prius and the like. “All Electric Drive Vehicle” or “AEDV” as referred to in this document refers to vehicles that utilize an electrical motor as the drive train power source and do not have an on board generator. Examples are the EV1 and converted vehicles such as the MGB Midget of David Coale and others. “Automobile Vehicle Pusher” or “AVP” as referred to in this document refers to the use of one or more electrical power storage devices and electrical propulsion apparatus, or other form of energy propulsion, and the apparatus is reversibly appended to the rear of a vehicle in order to provide all or a portion of the power of propulsion for the vehicle.

### SUMMARY OF THE INVENTION

An object of the present invention is to provide an automobile vehicle pusher (AVP) system and apparatus comprising the following elements: at least one electrical motor, at least one electric motor variable speed controller, at least one electrical power storage component, and a wiring harness, and further comprising a support frame for supporting all or a portion of the elements of the system or apparatus that comprises or connects to a bracket for attaching to a trailer hitch or similar device, wherein the support frame is appended to or includes a power transfer unit for transferring torque power to at least one wheel for propulsion, and wherein the support frame may optionally further comprise one or more of a safety chain, cable, wire, gauges, lights, reflectors, suspension unit, and miscellaneous fasteners, and the AVP is adapted to be reversibly coupled to the rear of a vehicle that has been modified to receive the coupling of the AVP in order to provide all or a portion of the propulsion of the vehicle.

In a preferred object, at least one electrical motor and a least one wheel propulsion assembly are coupled to a power transfer unit and both are attached to the support frame. For compliance with state or federal law, or for additional safety, automotive lights and reflectors can be added to improve visibility.

In another preferred object of the invention there is provided a suspension unit attached between parts of the frame and the attaching brackets, wherein attaching brackets are used to attach the AVP to an automotive vehicle, wherein the energy source from the energy power storage system connects to at least one motor controller and the at least one motor controller connects to the at least one motor.

In a still further object, the invention provides an embodiment with a wiring harness attached to the components of the AVP as described above is attached to a motor controller of the AVP and also attached to a variable speed controller control assembly located in the vehicle near the automotive vehicle driver, to provide a method for the vehicle driver to operate the variable speed controller and control the velocity of the vehicle.

In a still further object, the invention is such a system further providing a regen controller system that can be associated with the braking system of the vehicle to permit recycling of energy back to the electrical power storage system during braking of the vehicle. In addition, the AVP apparatus can comprise a mechanical braking apparatus that can be coordinated with the main vehicle's braking system to provide braking assistance.

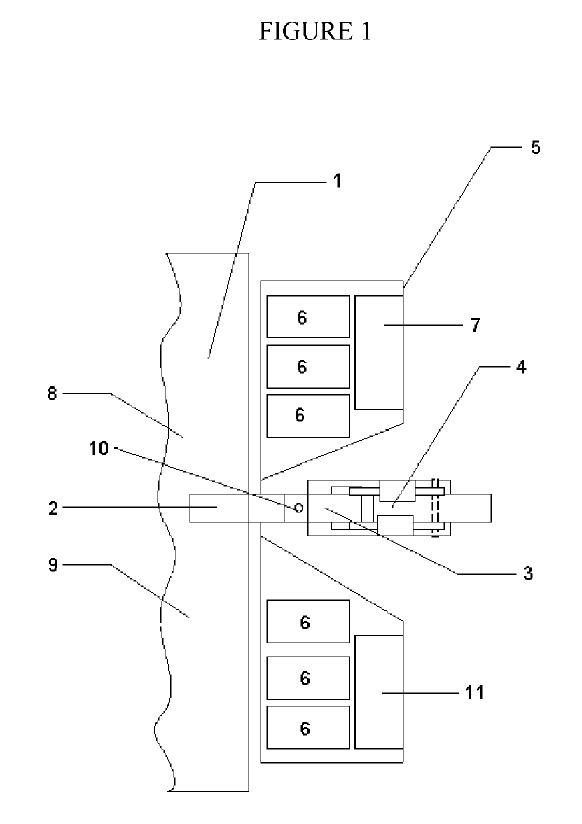

In a preferred object of the invention, the AVP comprises the elements as shown in FIG. 1.

In a further object of the invention, the AVP provides a method for reversibly converting an automobile vehicle in to an electric-only or hybrid propulsion system by providing electrical propulsion or electrical propulsion assistance to an automotive vehicle.

In yet another object of the invention, the AVP provides a method for reducing the hydrocarbon energy intake per mile of travel of an automotive vehicle's engine by increasing the miles per gallon of fuel consumption during vehicular motion, or to increase the performance of an automotive vehicle.

In one highly preferred object of the invention, the AVP is constructed to have its main attachment point to the automotive vehicle be the vehicle's standard trailer hitch receiver.

### DETAILED DESCRIPTION OF THE DRAWING

FIG. 1 shows a top view of an embodiment of the automotive vehicle pusher assembly attached to an automotive vehicle wherein 1 is the automotive vehicle, 2 is the attaching apparatus portion of the vehicle 1, 3 is the bracket for attaching the vehicle pusher assembly to the automotive vehicle 1, 4 is the power transfer unit or propulsion assembly of the vehicle pusher assembly, 5 is the support frame of the automotive vehicle pusher assembly that can optionally include lights, signals or reflectors, 6 is one or more electrical power storage components, 7 is an electrical motor controller, 8 is a variable speed controller located in the automotive vehicle 1 that is attached by a wiring harness (not shown) to the electrical motor controller 7, miscellaneous gauges and controls 9 are located in the automotive vehicle 1, a coupling device 10 is utilized to reversibly connect the attaching apparatus 2 of the vehicle and the bracket 3 of the vehicle pusher assembly, and 11 refers to fuses, power cutoff switches and other power control elements of the AVP assembly.

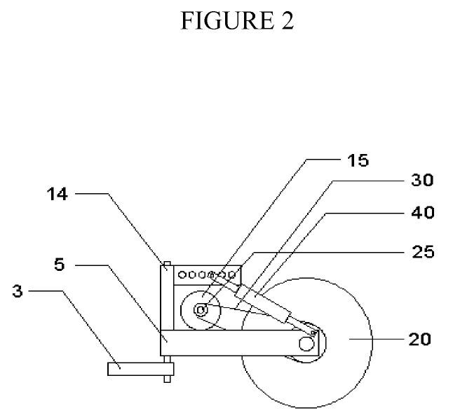

FIG. 2 is a side view showing further details of the power transfer unit or propulsion assembly 4 of the automotive vehicle pusher assembly shown in FIG. 1, wherein 3 is the bracket for attaching the vehicle pusher assembly to the automotive vehicle 1, 5 is the support frame of the automotive vehicle pusher assembly that can optionally include lights, signals or reflectors, 14 is an upper support bracket portion of the support frame 5, 15 is an electric motor for propulsion, 20 is a wheel assembly to transfer torque into propulsion in contact with a road surface, 25 is a connector attached to the electric motor 15 to transfer torque power to a power transfer apparatus 30 that in turn transfers torque power to the wheel assembly 20 to provide propulsion, and 40 is a suspension apparatus that may include one or more of a shock absorber, spring or a combination thereof.

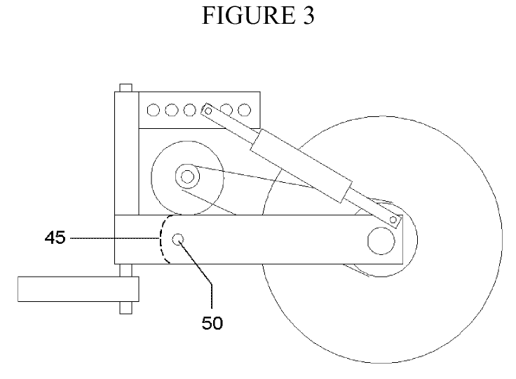

FIG. 3 is a side view showing further details of the power transfer unit or propulsion assembly similar to FIG. 2 with the additional features shown by groove 45 and pivot point 50 that collectively provide a hinge to permit up and down movement.

### DETAILED DESCRIPTION OF THE INVENTION

One embodiment of the invention provides an automobile vehicle pusher (AVP) system and apparatus comprising the following elements: at least one electrical motor, at least one electric motor variable speed controller, at least one electrical power storage component, and a wiring harness, and further comprising a support frame for supporting all or a portion of the elements of the system or apparatus that comprises or connects to a bracket for attaching to a trailer hitch or similar device, wherein the support frame is appended to or includes a power transfer unit for transferring torque power to at least one wheel for propulsion, and wherein the support frame may optionally further comprise one or more of a safety chain, cable, wire, gauges, lights, reflectors, suspension unit, and miscellaneous fasteners, and the AVP is adapted to be reversibly coupled to the rear of a vehicle that has been modified to receive the coupling of the AVP in order to provide all or provide only a portion of the propulsion for the vehicle.

In a preferred embodiment, the invention provides at least one electrical motor and a least one wheel propulsion assembly are coupled to a power transfer unit and both are attached to the support frame. For compliance with state or federal law, or for additional safety, automotive lights and reflectors can be added to improve visibility.

In another preferred embodiment, a suspension unit is attached between parts of the frame and the attaching brackets, wherein attaching brackets are used to attach the AVP to an automotive vehicle, wherein the energy source from the energy power storage system connects to at least one motor controller and the at least one motor controller connects to the at least one motor.

In a still further embodiment, a wiring harness attached to the components of the AVP as described above is attached to a motor controller of the AVP and also attached to a variable speed controller control assembly located in the vehicle near the automotive vehicle driver, to provide a method for the vehicle driver to operate the variable speed controller and control the velocity of the vehicle.

In a still further embodiment of the invention the system provides a regen controller system that can be associated with the braking system of the vehicle to permit recycling of energy back to the electrical power storage system during braking of the vehicle. In addition, the AVP apparatus can comprise a mechanical braking apparatus that can be coordinated with the main vehicle's braking system to provide braking assistance.

In a preferred embodiment of the invention, the AVP comprises the elements as shown in FIG. 1 as further described in FIG. 2.

In a further embodiment of the invention, the AVP provides a method for reversibly converting an automobile vehicle in to an electric-only or hybrid propulsion system by providing electrical propulsion or electrical propulsion assistance to an automotive vehicle.

In yet another embodiment of the invention, the AVP provides a method for reducing the hydrocarbon energy intake per mile of travel of an automotive vehicle's engine by increasing the miles per gallon of fuel consumption during vehicular motion, or to increase the performance of an automotive vehicle.

In one highly preferred embodiment, the AVP is constructed to have its main attachment point to the automotive vehicle be the vehicle's standard trailer hitch receiver.

Embodiments of the invention solve or reduce problems caused by the fuel crisis and further reduce environmental emissions by reducing an automotive vehicle's energy consumption and emissions per mile of travel. The Automotive Vehicle Pusher is an adaptive device that provides propulsion to assist in part or whole an automotive vehicle's engine. Thus, it reduces the amount of combustion energy required to propel a vehicle per mile of travel and takes advantage of plug-in technology to reduce the fuel costs per mile along with reducing the carbon footprint for the vehicle. Reducing the energy consumption of an automotive vehicle, and optionally utilizing electrical power from renewable sources reduces environmental emissions.

The AVP is a device that can be reversibly added to an existing automotive vehicle to provide propulsion in part or whole, and be readily disconnected and replaced when repairs are needed without the need to substantially alter the existing automotive vehicle. In other words it can provide all of the propulsion as a plug-in electric propulsion apparatus, or it can assist in the propulsion of an automotive vehicle as part of a hybrid propulsion system. In short, it is an attachable assembly that converts an automotive vehicle into a hybrid vehicle and can be attached to a wide range of vehicles.

In some embodiments it may be advantageous to locate some or all of the electrical power storage components or controlling apparatus within the vehicle, or to have such components of the system attached to the vehicle by apparatus separate from the AVP apparatus portion that includes the electrical motor propulsion assembly. In either event, the AVP system provides an alternate or supplemental means to propel or assist propelling an automotive vehicle. Attaching and implementing the AVP converts an automotive vehicle into an all-electric or into a hybrid vehicle since the AVP is controlled independently of the automotive vehicles engine. The AVP is a simple to install adaptive device that reversibly attaches to an automotive vehicle to provide propulsion to assist in part or whole the movement of an automotive vehicle. The Automotive Vehicle Pusher (AVP) consists of one or more motors, motor controllers, and an energy source that is attached to an automotive vehicle via various brackets. A power transfer unit transfers energy from the motor to a wheel or wheels thus providing vehicle motion. The suspension unit provides the required force to engage the wheel to the road surface. Miscellaneous components can include various lights, electrical components, switches, wires, fuses, pumps, brackets, framing, controllers, gauges, and tanks to provide the structure interfacing and activation.

In one preferred embodiment the AVP comprises the following parts: a motor, variable speed motor controller, electrical component, energy source, frame, attaching bracket, cable, chain, wire, gauges, lights, reflectors, power transfer unit, wheel, suspension unit, and miscellaneous fasteners wherein

(a) the motor and wheel assembles are coupled to the power transfer unit and are attached to the frame, and wherein a suspension unit is attached between parts of the frame and the attaching brackets wherein attaching brackets are used to attach the Automotive Vehicle Pusher to an automotive vehicle,

(b) the energy source connects to the motor controller and the motor controller connects to the motor and the automotive vehicle driver operates a variable speed controller to control the velocity of the vehicle, and

c) for compliance of state or federal law or for additional safety automotive lights and reflectors can be added to the AVP to improve visibility.

The AVP can be but is not limited to a construction so that the main attachment point is an automotive vehicle's standard hitch receiver and it can be reversibly used to electrify or hybridize an automotive vehicle.

While the AVP embodiments shown and described in detail are directed to electrical propulsion that supplements a vehicle movement, any form or ancillary propulsion can be utilized that is economical. Adapting the AVP to include such other forms of propulsion should be readily apparent upon reviewing the examples and description. For example, a pneumatic motor, energy source and controller may be utilized without departing from the scope of the invention.

The present invention may be embodied in specific forms other than those particularly described above or illustrated by the above examples. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and examples, as indicating the scope of the present invention.

I claim:

1. An automobile vehicle pusher (AVP) system and apparatus comprising the following portions at least one electrical motor or other ancillary propulsion means, at least one electric motor or other propulsion means variable speed controller, at least one electrical power or other energy storage component or at input device for accepting electrical power or other energy storage device from an external electrical power or other power storage component, at least one wiring harness, and a support frame, wherein
(a) the support frame supports all or a portion of the others portions (i)-(iv) of the system or apparatus and the support frame comprises or connects to a bracket for attaching to a trailer hitch or similar device,
(b) the support frame is appended to or includes a power transfer unit for transferring torque power to at least one wheel for propulsion, and
(c) the AVP is adapted to be reversibly coupled to the rear of a vehicle that has been modified to receive the coupling of the AVP in order to provide all or provide only a portion of the propulsion for the vehicle.

2. Av further comprising one or more of a safety chain, cable, wire, gauges, lights, reflectors, suspension unit, and miscellaneous fasteners

2. The AVP system and apparatus of claim 1, further comprising at least one electrical motor and a least one wheel propulsion assembly are coupled to a power transfer unit and both are attached to the support frame, wherein an attachment assembly of the AVP system can be attached to an automobile vehicle trailer hitch.

3. The AVP system and apparatus of claim 1, wherein automotive lights and reflectors are added to improve visibility and the system communicates with the vehicle's signaling and braking systems.

4. The AVP system and apparatus of claim 1, further comprising apparatus and software or hardware implemented methods to provide supplemental regenerative braking to recycle some of the energy of the vehicle, and optionally comprises mechanical braking apparatus that can be coordinated with the main vehicle's braking system to provide braking assistance.

5. The AVP system and apparatus of claim 1, further comprising a wiring harness attached to the components of the AVP as described above is attached to a motor controller of the AVP and also attached to a variable speed controller control assembly located in the vehicle near the automotive vehicle driver, to provide a method for the vehicle driver to operate the variable speed controller and control the velocity of the vehicle.

6. The AVP system and apparatus of claim 5, wherein the variable speed controller comprises one or more of hardware or software logic to provide regenerative braking.

7. The AVP of claim 1, wherein some or all of the electrical power storage components or controlling apparatus are located within the vehicle instead of being supported by the support frame that supports the propulsion components, or some or all of the electrical power storage components or controlling apparatus are located in or on other locations within the vehicle or its cargo compartments and may be attached to the vehicle by apparatus separate from the AVP apparatus portion that includes the electrical motor propulsion assembly.

8. The AVP of claim 1, further comprising a charging device or power converter to provide a plug-in electric only or hybrid automobile vehicle.

9. A method for reversibly converting an automobile vehicle in to an electric-only or hybrid propulsion system by providing electrical propulsion or electrical propulsion assistance to an automotive vehicle as a result of attaching and operating the AVP system and apparatus according to claim 1.

10. A method for by providing electrical propulsion or electrical propulsion assistance to an automotive vehicle and thereby reducing the hydrocarbon energy intake per mile of travel of an automotive vehicle's engine by increasing the miles per gallon of fuel consumption during vehicular motion, or to increase the performance of an automotive as a result of attaching and operating the AVP system and apparatus according to claim 1.
